(19) United States
(12) Patent Application Publication
(10) Pub. No.: US 2007/0042931 A1
(43) Pub. Date: Feb. 22, 2007

(54) Solid laundry detergent composition comprising anionic detersive surfactant and highly porous carrier material

(76) Inventors: Nigel Patrick Somerville Roberts, Newcastle-upon-Tyne (GB); John Peter Eric Muller, Newcastle-upon-Tyne (GB); Lourdes Marina Ramirez Hernandez, Newcastle-upon-Tyne (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/504,900

(22) Filed: Aug. 16, 2006

(30) Foreign Application Priority Data
Aug. 19, 2005 (EP) 05018030.6

(51) Int. Cl. C11D 17/00

(52) U.S. Cl. 510/447

(57) ABSTRACT

The present invention relates to a solid laundry detergent composition in particulate form, comprising: (a) anionic detersive surfactant; (b) a solid carrier material having: (i) a total pore volume of greater than 0.3 ml/g; (ii) an average pore diameter of greater than 3 micrometers; and (iii) a surface area of less than 1.0 m²/g; (c) from 0% to less than 5%, by weight of the composition, of zeolite builder; (d) from 0% to less than 5%, by weight of the composition, of phosphate builder and (e) optionally, from 0% to less than 5%, by weight of the composition, of silicate salt; wherein at least part of the anionic detersive surfactant and at least part of the solid carrier material are in the form of a co-particulate admix.

### FIELD OF THE INVENTION

The present invention relates to solid laundry detergent compositions comprising anionic detersive surfactant and a highly porous carrier material. The compositions of the present invention have a good cleaning performance, good dispensing and dissolution profiles, and good physical characteristics.

### BACKGROUND OF THE INVENTION

There have been relatively recent attempts by many detergent manufacturers to significantly improve the dissolution and dispensing performance of their granular laundry detergents. The approach many detergent manufacturers have focused on is the significant reduction in the level of, or even the complete removal of, water-insoluble builder, such as zeolite builder, in/from their granular laundry detergent formulations. However, due to the phosphate-usage avoidance legislation in many countries which prevents the detergent manufacturers from incorporating a sufficient amount of phosphate-based water-soluble builders, such as sodium tripolyphosphate, in their granular laundry detergents, and due to the lack of feasible alternative non-phosphate based water-soluble builders available to the detergent manufacturers, the approach many detergent manufacturers have focused on is to not completely replace the zeolite-based builder system with a water-soluble builder system having an equivalent degree of builder capability, but instead to formulate an under-built granular laundry detergent composition.

Whilst this under-built approach does significantly improve the dissolution and dispensing performance of the granular laundry detergent, problems do exist due to the significant amount of cations, such as calcium, that are not removed from the wash liquor by the builder-system of the granular laundry detergent composition during the laundering process. These cations interfere with the anionic detersive surfactant system of the granular laundry detergent composition in such a manner as to cause the anionic detersive surfactant to precipitate out of solution, which leads to a reduction in the anionic detersive surfactant activity and cleaning performance. In extreme cases, these water-insoluble complexes may deposit onto the fabric resulting in poor whiteness maintenance and poor fabric integrity benefits. This is especially problematic when the laundry detergent is used in hard-water washing conditions when there is a high concentration of calcium cations.

Another problem that needs to be overcome when the level of water-insoluble builders such as zeolite are significantly reduced in the composition, or when the zeolite is completely removed from the formulation, is the poor physical characteristics of the composition, especially after storage, which result in a poor cake strength.

The Inventors have found that the cleaning performance and physical characteristics of under-built detergent compositions is improved by using an anionic detersive surfactant in combination with a highly porous carrier material.

U.S. Pat. No. 5,552,078 by Carr et al, Church & Dwight Co. Inc., relates to a powdered laundry detergent composition comprising an active surfactant. It is alleged that compositions of U.S. Pat. No. 5,552,078 exhibit excellent cleaning and whitening of fabrics whilst avoiding the problem of eutrophication which occurs when a substantial amount of phosphate-builder is present in the composition, and while minimizing the problem of fabric-encrustation often present when the composition contains a large amount of carbonate builder.

U.S. Pat. No. 6,274,545 B 1 by Mazzola, Church & Dwight Co. Inc., relates to a high-carbonate low-phosphate powder laundry detergent formulation which can allegedly be utilized in cold water fabric laundering with a minimized remainder of undissolved detergent residue in the wash liquor. The detergent composition of U.S. Pat. No. 6,274,545 B1 comprises an anionic/nonionic surfactant blend that is a partially sulphated and neutralized ethoxylated alcohol surfactant, and a polyethylene glycol ingredient, which allegedly increases the solubility of the laundry detergent solids in the wash liquor.

WO97/43366 by Askew et al, The Procter & Gamble Company, relates to a detergent composition that comprises an effervescence system. WO97/43366 exemplifies a carbonate built bleach-free detergent composition.

WO00/18873 by Hartshorn et al, The Procter & Gamble Company, relates to detergent compositions having allegedly good dispensing performance and allegedly do not leave residues on the fabric after the laundering process.

WO00/18859 by Hartshorn et al, The Procter & Gamble Company, relates to detergent compositions allegedly having an improved delivery of ingredients into the wash liquor during the laundering process. The compositions of WO00/18859 allegedly do not as readily gel upon contact with water and allegedly do not leave water-insoluble residues on clothes after the laundering process. The compositions of WO/00/18859 comprise a predominantly water-soluble builder system that is intimately mixed with a surfactant system.

WO02/053691 by Van der Hoeven et al, Hindustain Lever Limited, relates to a laundry detergent composition comprising greater than 10 wt % of a calcium tolerant surfactant, from 0.1 wt % to 10 wt % of a strong builder system selected from phosphate builders and/or zeolite builders, and less than 35 wt % of non-functional non-alkaline water-soluble inorganic salts.

None of these prior art documents relate to under-built solid laundry detergent compositions that comprise a combination of an anionic detersive surfactant and a highly porous carrier material.

### SUMMARY OF THE INVENTION

In a first embodiment, the present invention provides a solid laundry detergent composition in particulate form, comprising: (a) anionic detersive surfactant; (b) a solid carrier material having: (i) a total pore volume of greater than 0.3 ml/g; (ii) an average pore diameter of greater than 3 micrometers; and (iii) a surface area of less than 1.0 m²/g; (c) from 0% to less than 5%, by weight of the composition, of zeolite builder; (d) from 0% to less than 5%, by weight of the composition, of phosphate builder and (e) optionally, from 0% to less than 5%, by weight of the composition, of silicate salt; wherein at least part of the anionic detersive surfactant and at least part of the solid carrier material are in the form of a co-particulate admix.

In a second embodiment, the present invention provides a process for preparing the above-described composition, the process comprising the steps of: (a) contacting a starting material with water to form an aqueous mixture; (b) drying the aqueous mixture at an inlet temperature of at least 300° C., or at least 400° C., or at least 500° C., or at least 600° C., for a period of time of less than 30 seconds, or less than 20 seconds, or less than 10 seconds to form the solid carrier material; (c) contacting the solid carrier material with an anionic detersive surfactant to form a co-particulate admix; and (d) optionally, contacting the co-particulate admix with one or more adjunct ingredients to form a solid laundry detergent composition.

### DETAILED DESCRIPTION OF THE INVENTION

Solid Laundry Detergent Composition

The composition comprises anionic detersive surfactant, a solid carrier material, from 0 to less than 5%, by weight of the composition, of zeolite builder, from 0% to less than 5%, by weight of the composition, of phosphate builder, and optionally from 0% to less than 5%, by weight of the composition, of silicate salt. The composition may comprise other adjunct components.

The composition is in particulate form, such as an agglomerate, a spray-dried power, an extrudate, a flake, a needle, a noodle, a bead, or any combination thereof. The composition may be in compacted-particulate form, such as in the form of a tablet. The composition may in some other unit dose form; such as in the form of a pouch, typically being at least partially, preferably essentially completely, enclosed by a water-soluble film such as polyvinyl alcohol. Preferably, the composition is in free-flowing particulate form; by free-flowing particulate form, it is typically meant that the composition is in the form of separate discrete particles. The composition may be made by any suitable method including agglomeration, spray-drying, extrusion, mixing, dry-mixing, liquid spray-on, roller compaction, spheronisation, tabletting or any combination thereof.

The composition typically has a bulk density of from 450 g/l to 1,000 g/l, preferred low bulk density detergent compositions have a bulk density of from 550 g/l to 650 g/l and preferred high bulk density detergent compositions have a bulk density of from 750 g/l to 900 g/l.

During the laundering process, the composition is typically contacted with water to form a wash liquor having a pH of from above 7 to less than 13, preferably from above 7 to less than 10.5. This is the optimal pH to provide good cleaning whilst also ensuring a good fabric care profile.

At least part of, preferably essentially all of, the anionic detersive surfactant and at least part of, preferably essentially all of, the solid carrier material are present in the composition in the form of a co-particulate admix. By co-particulate admix it is typically meant that at least part of, preferably all of, the anionic detersive surfactant and at least part of, preferably all of, the solid carrier material are present in the composition in the same particle. The co-particulate admix can be in the form of an agglomerate, a spray-dried power, an extrudate, a flake, a needle, a noodle, a bead. Preferably the co-particulate admix is in the form of an agglomerate, and when the co-particulate admix is in the form of an agglomerate, preferably the co-particulate admix comprises from 10% to 70%, or from 15%, or from 20%, or from 25%, or from 30%, or from 35%, or from 40%, and to 60%, or to 50%, by weight of the co-particulate admix, of anionic detersive surfactant; and preferably the co-particulate admix comprises from 20% to 70%, or from 30%, or from 40%, or from 50%, and preferably to 60%, by weight of the co-particulate admix, of solid carrier material. However, the co-particulate admix may be in spray-dried form, if the co-particulate admix is in spray-dried form, then preferably the co-particulate admix comprises from 5% to 50%, or from 6%, or from 7%, or from 8%, or from 9%, or from 10%, and to 40%, or to 30%, or to 20%, by weight of the co-particulate admix, of anionic detersive surfactant; and preferably the co-particulate admix comprises from 10% to 80%, or from 15%, or from 20%, or from 25%, or from 30%, and to 70%, or to 60%, or to 50%, or to 40%, by weight of the co-particulate admix, of solid carrier material.

The co-particulate admix that comprises anionic detersive surfactant and solid carrier material typically has a particle size distribution such that the weight average particle size of the co-particulate admix is preferably in the range of from 100 micrometers to 1,000 micrometers, preferably from 250 micrometers, or from 500 micrometers and preferably to 800 micrometers, and preferably no more than 10 wt %, preferably no more than 5 wt % of the co-particulate admix has a particle size less than 150 micrometers and preferably no more than 10 wt %, preferably no more than 5 wt % of the co-particulate admix has a particle size of more than 1180 micrometers.

The composition typically has an equilibrium relative humidity of from 0% to less than 30%, preferably from 0% to 20%, when measured at a temperature of 35° C. Typically, the equilibrium relative humidity is determined as follows: 300 g of composition is placed in a 1 litre container made of a water-impermeable material and fitted with a lid capable of sealing the container. The lid is provided with a sealable hole adapted to allow insertion of a probe into the interior of the container. The container and its contents are maintained at a temperature of 35° C. for 24 hours to allow temperature equilibration. A solid state hygrometer (Hygrotest 6100 sold by Testoterm Ltd, Hapshire, UK) is used to measure the water vapour pressure. This is done by inserting the probe into the interior of the container via the sealable hole in the container's lid and measuring the water vapour pressure of the head space. These measurements are made at 10 minute intervals until the water vapour pressure has equilibrated. The probe then automatically converts the water vapour pressure reading into an equilibrium relative humidity value.

Preferably, the composition upon contact with water at a concentration of 9.2 g/l and at a temperature of 20° C. forms a transparent wash liquor having (i) a turbidity of less than 500 nephelometric turbidity units; and (ii) a pH in the range of from 8 to 12. Preferably, the resultant wash liquor has a turbidity of less than 400, or less than 300, or from 10 to 300 nephelometric turbidity units. The turbidity of the wash liquor is typically measured using a H1 93703 microprocessor turbidity meter. A typical method for measuring the turbidity of the wash liquor is as follows: 9.2 g of composition is added to 1 litre of water in a beaker to form a solution. The solution is stirred for 5 minutes at 600 rpm at 20° C. The turbidity of the solution is then measured using a H1 93703 microprocessor turbidity meter following the manufacturer's instructions.

Anionic Detersive Surfactant

The detergent composition comprises anionic detersive surfactant. Preferably, the composition comprises from 5% to 25%, by weight of the composition, of anionic detersive surfactant. Preferably, the composition comprises from 6% to 20%, or from 7% to 18%, or from 8% to 15%, or from 8% to 11% or even from 9% to 10%, by weight of the composition, of anionic detersive surfactant.

The anionic detersive surfactant is preferably selected from the group consisting of: linear or branched, substituted or unsubstituted C₈₋₁₈ alkyl sulphates; linear or branched, substituted or unsubstituted C₈₋₁₈ linear alkylbenzene sulphonates; linear or branched, substituted or unsubstituted C₈₋₁₈ alkyl alkoxylated sulphates having an average degree of alkoxylation of from 1 to 20; linear or branched, substituted or unsubstituted C₁₂₋₁₈ alkyl carboxylates; and mixtures thereof. The anionic detersive surfactant can be an alkyl sulphate, an alkyl sulphonate, an alkyl phosphate, an alkyl phosphonate, an alkyl carboxylate or any mixture thereof. The anionic surfactant can be selected from the group consisting of: C₁₀-C₁₈ alkyl benzene sulphonates (LAS), preferably linear C₁₀-C₁₃ alkyl benzene sulphonates; C₁₀-C₂₀ primary, branched-chain, linear-chain and random-chain alkyl sulphates (AS), preferred are linear alkyl sulphates, typically having the following formula:
CH₃(CH₂)×CH₂—OSO₃⁻M⁺,
wherein, M is hydrogen or a cation which provides charge neutrality, preferred cations include sodium and ammonium cations, wherein x is an integer of at least 7, preferably at least 9; C₁₀-C₁₈ secondary (2,3) alkyl sulphates having the following formulae: 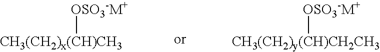
wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₈ alkylbenzene sulphonates, preferably linear C₁₀₋₁₃ alkylbenzene sulphonates; linear or branched, substituted or unsubstituted alkyl alkoxylated sulphates having an average degree of alkoxylation of from 1 to 20, preferably linear C₁₀₋₁₈ alkyl ethoxylated sulphates having an average degree of ethoxylation of from 3 to 7; and mixtures thereof. Highly preferred are commercially available C₁₀₋₁₃ linear alkylbenzene sulphonates. Highly preferred are linear C₁₀₋₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol Under the Tradename Hyblene®.

It may be preferred for the anionic detersive surfactant to be structurally modified in such a manner as to cause the anionic detersive surfactant to be more calcium tolerant and less likely to precipitate out of the wash liquor in the presence of free calcium ions. This structural modification could be the introduction of a methyl or ethyl moiety in the vicinity of the anionic detersive surfactant's head group, as this can lead to a more calcium tolerant anionic detersive surfactant due to steric hindrance of the head group, which may reduce the anionic detersive surfactant's affinity for complexing with free calcium cations in such a manner as to cause precipitation out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may minimise the undesirable physicochemical property of the anionic detersive surfactant to form a smooth crystal structure in the presence of free calcium ions in the wash liquor. This may reduce the tendency of the anionic detersive surfactant to precipitate out of solution.

The composition preferably comprises alkoxylated alkyl anionic detersive surfactant, preferably from 0.1% to 10%, by weight of the composition, of alkoxylated alkyl anionic detersive surfactant. This is the optimal level of alkoxylated alkyl anionic detersive surfactant to provide good greasy soil cleaning performance, to give a good sudsing profile, and to improve the hardness tolerancy of the overall detersive surfactant system. It may be preferred for the composition to comprise from 3% to 5%, by weight of the composition, alkoxylated alkyl anionic detersive surfactant, or it may be preferred for the composition to comprise from 1% to 3%, by weight of the composition, of alkoxylated alkyl anionic detersive surfactant.

Preferably, the alkoxylated alkyl anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated alkyl anionic detersive surfactant is a linear or branched, substituted or unsubstituted C₁₂₋₁₈ alkyl ethoxylated sulphate having an average degree of ethoxylation of from 1 to 10. Most preferably, the alkoxylated alkyl anionic detersive surfactant is a linear unsubstituted C₁₂₋₁₈ alkyl ethoxylated sulphate having an average degree of ethoxylation of from 3 to 7.

Preferably, at least part of, more preferably all of, the alkoxylated alkyl anionic detersive surfactant is in the form of a non-spray-dried powder such as an extrudate, agglomerate, preferably an agglomerate. This is especially preferred when it is desirable to incorporate high levels of alkoxylated alkyl anionic detersive surfactant in the composition.

The alkoxylated alkyl anionic detersive surfactant may also increase the activity of non-alkoxylated anionic detersive surfactant, if present, by making the non-alkoxylated anionic detersive surfactant less likely to precipitate out of solution in the presence of free calcium cations. Preferably, the weight ratio of non-alkoxylated anionic detersive surfactant to alkoxylated alkyl anionic detersive surfactant is less than 5:1, or less than 3:1, or less than 1.7:1, or even less than 1.5:1. This ratio gives optimal whiteness maintenance performance combined with a good hardness tolerency profile and a good sudsing profile. However, it may be preferred that the weight ratio of non-alkoxylated anionic detersive surfactant to alkoxylated alkyl anionic detersive surfactant is greater than 5:1, or greater than 6:1, or greater than 7:1, or even greater than 10:1. This ratio gives optimal greasy soil cleaning performance combined with a good hardness tolerency profile, and a good sudsing profile.

Suitable alkoxylated anionic detersive surfactants are: Texapan LEST™ by Cognis; Cosmacol AES™ by Sasol; BES151™ by Stephan; Empicol ESC70/U™; and mixtures thereof.

Solid Carrier Material

The composition comprises a solid carrier material. The solid carrier material has a total pore volume of greater than 0.3 ml/g, preferably greater than 0.4 ml/6, or greater than 0.5 ml/g, or greater than 0.6 ml/g, or greater than 0.7 ml/g, or greater than 0.8 ml/g, or greater than 0.9 ml/g, or greater than 1.0 ml/g. The total pore volume of the solid carrier material is typically determined by mercury porosimetry using a sieved particulate size range of 250-300 micrometers and where only pores of less than 30 micrometers are considered for the determination of the total pore volume. More details of mercury porosimetry can be found in: “Analytical methods of fine particle technology” by Webb, P. and Orr, C., Micromeretics Instrument Corporation, Norcross, Ga., USA; ISBM 0-9656783-0-X. Only pores of less than 30 micrometers are considered for the determination of the total pore volume in order to avoid the inclusion of unwanted inter-particulate porosity in the calculations to determine the total pore volume of the solid carrier material. Any suitable mercury porosimetry method and equipment can be used.

The solid carrier material has an average pore diameter of greater than 3 micrometers or greater than 4 micrometers, preferably greater than 5 micrometers, or greater than 6 micrometers, or greater than 7 micrometers, or greater than 8 micrometers, or greater than 9 micrometers, or greater than 10 micrometers. The average pore diameter of the solid carrier material is typically determined by mercury porosimetry using a sieved particulate size range of 250-300 micrometers and where only pores of less than 30 micrometers are considered for the determination of the average pore diameter. The pores are typically assumed to be right cylinders for the determination of the average pore diameter. More details of mercury porosimetry can be found in: “Analytical methods of fine particle technology” by Webb, P. and Orr, C., Micromeretics Instrument Corporation, Norcross, Ga., USA; ISBM 0-9656783-0-X. Only pores of less than 30 micrometers are considered for the determination of the average pore diameter in order to avoid the inclusion of unwanted inter-particulate porosity in the calculations to determine the average pore diameter of the solid carrier material. Any suitable mercury porosimetry method and equipment can be used.

The solid carrier material has a granule surface area of less than 1.0 m²/g, preferably less than 0.5 m²/g, preferably less than 0.4 m²/g or less than 0.3 m²/g, or less than 0.2 m²/g, or less than 0.10 m²/g, or less than 0.05 m²/g. The granule surface area of the solid carrier material is typically determined using a micromeretics Gemini 2360 surface area analyzer typically utilizing helium and nitrogen gas to calculate a granule surface area, which is typically a BET surface area, typically a multi-point BET surface area. Typically, in order to determine the granule surface area, five data points are collected, each using the following gas molar volume ratios: (i) 5:95 nitrogen:helium; (ii) 10:90 nitrogen:helium, (iii) 15:85 nitrogen:helium; (iv) 20:80 nitrogen:helium; and (v) 30:70 nitrogen:helium. A suitable method for determining the granule surface area from this data can be found in “Analytical methods of fine particle technology” by Webb, P. and Orr, C., Micromeretics Instrument Corporation, Norcross, Ga., USA; ISBM 0-9656783-0-X.

The solid carrier material is typically water-soluble. By water-soluble it is typically meant that the solid carrier material has a solubility of at least 50%, preferably at least 75% or even at least 95%, as measured by the following water-solubility method: 50 grams of the solid carrier material is dosed into a pre-weighed 400 ml beaker, and 245 ml ml of distilled water is then dosed into the beaker. The water and solid carrier material in the beaker are stirred vigorously on magnetic stirrer set at 600 rpm, for 30 minutes. Then, the resultant mixture is filtered through a folded qualitative sintered-glass filter having a pore size of 20 micrometers. The water is dried off from the collected filtrate by any conventional method, and the weight of the remaining solid carrier material is determined. Then, the % solubility is then calculated by determining the wt% of the solid carrier material that dissolves in the water and does not form part of the filtrate collected on the filter paper.

The solid carrier material is preferably a salt such as sodium sulphate and/or sodium carbonate, preferably a salt in high temperature-dried form, typically being subjected to a drying temperature of greater than 300° C., or greater than 400° C., or greater than 500° C., or flash-dried form, preferably sodium carbonate and/or sodium sulphate in high temperature-dried form or flash dried form, preferably sodium sulphate in high temperature-dried form or flash-dried form. High temperature drying and flash-drying are suitable means for ensuring that the solid carrier material is highly porous and has the required total pore volume, average pore diameter and surface area.

Zeolite Builder

The composition comprises from 0% to less than 5%, or to 4%, or to 3%, or to 2%, or to 1%, by weight of the composition, of zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

Phosphate Builder

The composition comprises from 0% to less than 5%, or to 4%, or to 3%, or to 2%, or to 1%, by weight of the composition, of phosphate builder. It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.

Silicate Salt

The composition optionally comprises from 0% to less than 5%, or to 4%, or to 3%, or to 2%, or to 1%, by weight of the composition, of silicate salt. It may even be preferred for the composition to be essentially free from silicate salt. By essentially free from silicate salt it is typically meant that the composition comprises no deliberately added silicate. This is especially preferred in order to ensure that the composition has a very good dispensing and dissolution profiles and to ensure that the composition provides a clear wash liquor upon dissolution in water. Silicate salts include water-insoluble silicates. Silicate salts include amorphous silicates and crystalline layered silicates (e.g. SKS-6). A preferred silicate salt is sodium silicate.

Adjunct Ingredients

The composition typically comprises adjunct ingredients. These adjunct ingredients include: detersive surfactants such as nonionic detersive surfactants, cationic detersive surfactants, zwitterionic detersive surfactants, amphoteric detersive surfactants; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₁₀₋₁₈ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; dyes such as orange dye, blue dye, green dye, purple dye, pink dye, or any mixture thereof; carbonate salt such as sodium carbonate and/or sodium bicarbonate; carboxylate polymers such as co-polymers of maleic acid and acrylic acid.

Preferably, the composition comprises less than 1 wt % chlorine bleach and less than 1 wt % bromine bleach. Preferably, the composition is essentially free from bromine bleach and chlorine bleach. By “essentially free from” it is typically meant “comprises no deliberately added”.

Process for Preparing a Composition

The process for preparing the above described composition comprises the steps of (a) contacting a starting material with water to form an aqueous mixture; (b) drying the aqueous mixture to form a solid carrier material; (c) contacting the solid carrier material with an anionic detersive surfactant to form a co-particulate admix; and (d) optionally, contacting the co-particulate admix with one or more adjunct ingredients.

Step (a): Contacting a Starting Material with Water to Form an Aqueous Mixture

During step (a), a starting material is contacted with water to form an aqueous mixture. The starting material can be any material that forms a highly porous solid carrier material having the required total pore volume, average pore diameter and surface area. Typically, the starting material is a salt, typically sodium sulphate and/or sodium carbonate, preferably sodium sulphate. Preferably, the starting material is in fine particulate form, typically having a weight average particle size of from 10 micrometers to 50 micrometers.

Preferably, the starting material is substantially dissolved in the water during step (a), by substantially dissolved it is typically meant that at least 70 wt %, or at least 80 wt %, or at least 90 wt %, or even at least 95 wt %, or even 99 wt % or 100 wt % of the starting material is dissolved in the water during step (a): preferably the starting material is essentially completely dissolved in the water during step (a).

It may be preferred that the aqueous mixture undergoes a filtering step between steps (a) and (b) to remove any undissolved ingredients from the aqueous mixture. Ensuring that the starting material is highly dissolved, preferably essentially completely dissolved, during step (a) removes unwanted nucleation sites from the starting material, which helps give the solid carrier material the optimal particle morphology.

Step (b): Drying the Aqueous Mixture to Form a Solid Carrier Material

During step (b), the aqueous mixture is dried to form the solid carrier material. The aqueous mixture is dried, typically in drying zone, for example a spray-drying tower, fluidized bed, etc, at an inlet gas temperature of at least 300° C., preferably greater than 400° C., or greater than 500° C,, or greater than 600° C. for a period of time of less than 60, or less than 40 seconds, or less than 20 seconds, or less than 10 seconds to form the solid carrier material. The solid carrier material is described in more detail above. Preferably step (b) is a high-temperature drying step or a flash-drying step. The gas used in the drying step can be air or water, which is typically in the form of super-heated steam.

Typically drying conditions encountered during usual drying processes for preparing laundry detergent compositions are not hot enough to result in a solid carrier material having the required highly porous characteristic. The drying step of the present invention is typically carried out at higher temperatures that those typically encountered during typical drying processes for preparing laundry detergent compositions. In order to avoid the unwanted thermal degradation of the ingredients undergoing the high-temperature or flash-drying step, the period of time of the drying step is limited: the mean residency time in the drying equipment is limited.

Step (c): Contacting the Solid Carrier Material with an Anionic Detersive Surfactant to Form a Co-Particulate Admix

During step (c), the solid carrier material is contacted with an anionic detersive surfactant to form a co-particulate admix. Step (c) can be carried out in any suitable vessel, preferably a mixer such as a high-speed mixer or a medium-speed mixer. Suitable high-shear mixers include CB Loedige mixers, Schugi mixers, Littleford or Drais mixers and lab scale mixers such as Braun mixers. Preferably the high-shear mixer is a pin mixer such as a CB Loedige mixer or Littleford or Drais. The high-shear mixers are typically operated at high speed, preferably having a tip speed of from 10 ms⁻¹ to 35 ms⁻¹. Suitable medium-shear mixers include Ploughshear mixers such as a Loedige KM. Preferably the medium-shear mixer has a tip speed of from above 0 ms⁻¹ to less than 10 ms⁻¹. Optionally a liquid binder such as water can be contacted to the solid carrier material and the anionic detersive surfactant during step (c), this can help control the rate of agglomeration of the co-particulate admix and ensure that the co-particulate admix has good physical characteristics.

The highly porous solid carrier material obtained in step (b) makes an excellent carrier material for the anionic detersive surfactant being capable of adequately absorbing and/or adsorbing the anionic surfactant and resulting in a co-particulate component having good physical characteristics, especially after storage.

Step (d): Contacting the Co-Particulate Admix with One or More Adjunct Ingredients to Form a Solid Laundry Detergent Composition

Step (d) is optional. During step (d), the co-particulate admix is contacted with one ore more adjunct ingredients. Step (d) can be carried out in any suitable vessel such as a mixing drum. Step (d) can also be carried out on a conveyor belt, which typically conveys the materials into a mixing vessel for a final mixing step.

### EXAMPLES

An aqueous saturated solution of sodium sulphate is heated to 50° C., atomized and sprayed into a counter-current spray-drying tower with a gas (air) inlet temperature of 550° C. The aqueous saturated solution of sodium sulphate is dried for 15 seconds to produce a highly porous sodium sulphate particle.

200 g of the above described sodium sulphate particle is mixed with 100 g aqueous surfactant paste comprising 70 wt % alkyl ethoxylated sulphate surfactant having an average ethoxylation degree of 3, in a Braun mixer at maximum speed for 20 seconds to form wet agglomerates. The wet agglomerates are then dried in a fluid bed having a gas (air) inlet temperature of 110° C. until the fluidized powder reaches a bulk temperature of 70° C. to form dry agglomerates.

1. A solid laundry detergent composition in particulate form, comprising:
(a) anionic detersive surfactant;
(b) a solid carrier material having:
(i) a total pore volume of greater than 0.3 ml/g;
(ii) an average pore diameter of greater than 3 micrometers; and
(iii) a surface area of less than 1.0 m²/g;
(c) from 0% to less than 5%, by weight of the composition, of zeolite builder;
(d) from 0% to less than 5%, by weight of the composition, of phosphate builder and
(e) optionally, from 0% to less than 5%, by weight of the composition, of silicate salt;
wherein at least part of the anionic detersive surfactant and at least part of the solid carrier material are in the form of a co-particulate admix.

2. A composition according to claim 1, wherein the solid carrier material has:
(i) a total pore volume of greater than 0.6 ml/g;
(ii) an average pore diameter of greater than 6 micrometers; and
(iii) a granule surface area of less than 0.2 m²/g.

3. A composition according to claim 1, wherein the solid carrier material is sodium sulphate in high temperature-dried form.

4. A process for preparing a composition according to claim 1, the process comprising the steps of:
(a) contacting a starting material with water to form an aqueous mixture; and
(b) drying the aqueous mixture at an inlet gas temperature of at least 300° C., for a period of time of less than 20 seconds to form the solid carrier material;
(c) contacting the solid carrier material with an anionic detersive surfactant to form a co-particulate admix; and
(d) optionally, contacting the co-particulate admix with one or more adjunct ingredients.

5. A process according to claim 4, wherein the starting material in step (a) is in fine particulate form, having a weight average particle size of from 10 micrometers to 50 micrometers.

6. A process according to claim 4, wherein in step (a) the starting material is essentially completely dissolved in the water.

7. A process according to claim 4, wherein the solid carrier material obtained in step (b) has:
(i) a total pore volume of greater than 0.6 ml/g;
(ii) an average pore diameter of greater than 6 micrometers; and
(iii) a granule surface area of less than 0.2 m²/g.

8. A solid laundry detergent composition that is obtainable by the process according to claims 4.
